(19) United States
(12) Patent Application Publication
(10) Pub. No.: US 2013/0286305 A1
(43) Pub. Date: Oct. 31, 2013

(54) 3D DISPLAY DEVICE AND PHASE RETARDER FILM THEREOF

(71) Applicants: Chia-chiang Hsiao, Shenzhen (CN); Chih-wen Chen, Shenzhen (CN)

(72) Inventors: Chia-chiang Hsiao, Shenzhen (CN); Chih-wen Chen, Shenzhen (CN)

(21) Appl. No.: 13/574,526

(22) PCT Filed: May 4, 2012
(86) PCT No.: PCT/CN2012/075078

§ 371 Date: Jul. 20, 2012

(30) Foreign Application Priority Data
Apr. 26, 2012 (CN) 201210126245.X

(51) Int. Cl. G02F 1/1335

(52) U.S. Cl. 349/15; 349/117

(57) ABSTRACT

The present invention discloses a 3D display device and a phase retarder film thereof. The phase retarder film is used to be mounted on an outer surface of a polarizer and has a plurality of first phase retarder rows; and a plurality of second phase retarder rows being arranged alternately with the first phase retarder rows. Each two of the adjacent first phase retarder rows and second phase retarder rows have a non-retardation row disposed therebetween. The non-retardation row has an optical axis being perpendicular or parallel to a transmission axis of the polarizer. The non-retardation row can reduce the brightness at boundary regions between phase-retarding areas and further improve image-crosstalk when the phase retarder film is mounted with a positional error.

### BACKGROUND OF THE INVENTION

1. Field of the Invention

The present invention relates to a 3D image display technology, especially to a 3D display device and a phase retarder film thereof.

2. Description of the Related Art

Because there is a distance between two eyes of a person, each of the eyes watches an object from a different direction. Therefore, a 3D display device uses human interocular difference to provide different images to the eyes, respectively, to generate a three-dimensional effect.

With reference to FIG. 1, a conventional 3D display system is disclosed and has a phase retarder film constituted by a patterned half-wave phase retarder layer 90 and a quarter-wave phase retarder layer 91 and mounted on a light-exiting surface of a liquid crystal display panel so as to output images having different polarization directions to an observer; and the observer wears a pair of polarized glasses 7 to receive the images having one polarization direction with his left eye and receive the images having another polarization direction with his right eye so as to create three-dimensional images in his brain. Generally speaking, the liquid crystal display panel of the 3D-display system uses images displayed by odd (or even) pixel rows as left-eye input images and images displayed by the other pixel rows as right-eye input images.

With reference to FIG. 1, images of the liquid crystal display panel of the 3D-display system will first travel through a polarizer to become linearly polarized images 80. The linearly polarized images 80 then travel through the patterned half-wave phase retarder film 90. Light of the linearly polarized images will be separated into two sets of linearly polarized images 81 with mutually perpendicular polarization directions. The two sets of linearly polarized images 81 then travel through the quarter-wave phase retarder film 91 and output images 82 including left-handed circularly polarized images and right-handed circularly polarized images for being the left-eye input images and right-eye input images. Each of the lenses 71, 72 of polarized glasses 7 worn by the observer is constituted by a quarter-wave plates and a polarizer. The left-handed circularly polarized images and right-handed circularly polarized images 82 first travel through the quarter-wave plates of the lenses 71, 72 to be converted into linearly polarized images and then travel through the polarizers of the lenses 71, 72 and arrive at the left and right eyes, respectively. Because the polarizers of the lenses 71, 72 has different polarization directions, the user's left eye can only see the left-eye input images and the right eye can only see the right-eye input images. Hence, it can achieve a three-dimensional effect.

With reference to FIG. 2, FIG. 2 is a partial schematic view of a conventional phase retarder film. The phase retarder film 60 is constituted by a quarter-wave liquid crystal retarder film and a patterned half-wave liquid crystal retarder film. The phase retarder film 60 has a plurality of first phase retarder areas 60A and a plurality of second phase retarder areas 60B, wherein the first phase retarder areas 60A and the second phase retarder areas 60B are alternately arranged and have different liquid crystal orientations.

With reference to FIG. 3, FIG. 3 is a partial schematic view showing the phase retarder film in FIG. 2 correspondingly mounted on a liquid crystal display panel. In general, the liquid crystal display panel includes a plurality of gate lines 51, a plurality of data lines 50 being crossed with the gate lines 51 and a plurality of pixel area 52 being defined by the gate lines 51 and the data lines 50. The pixel areas 52 are arranged in a matrix form and are divided into a plurality of pixel rows. Borders between the adjacent first phase retarder areas 60A and the second phase retarder areas 60B of the phase retarder film are respectively positioned between the adjacent pixel rows. The borders orders between the adjacent first phase retarder areas 60A and the second phase retarder areas 60B are covered by black matrix 53 between the adjacent pixel rows.

However, a conventional attachment machine for phase retarder films has an attachment error of about 20 mm while attaching the phase retarder films. Since the liquid crystal in the first phase retarder areas 60A and the liquid crystal in the second phase retarder areas 60B have different orientations and are closely arranged side by side, an irregular orientation of the liquid crystal molecules may occur in the borders. When a positional error occurs, one of the phase retarder areas where liquid crystal molecules are oriented in one direction corresponding to one eye may shift to a pixel area that is for another eye, and then one of the observer's eyes may see the input image that is for another eye, leading to image crosstalk.

Therefore, it is necessary to provide a 3D display device and a phase retarder film thereof to overcome the problems existing in the conventional technology.

### SUMMARY OF THE INVENTION

In view of the shortcomings of the conventional technology, the main objective of the invention is to provide a 3D display device and a phase retarder film thereof, wherein a liquid crystal layer with an orientation direction, which is perpendicular to or parallel to a transmission axis of a polarizer of a liquid crystal display panel, is disposed at the boundary regions between phase-retarding areas of a patterned phase retarder film so as to reduce the brightness at the boundary regions between the phase-retarding areas and further to improve possible image crosstalk when the phase retarder film is mounted with a positional error.

In order to achieve the foregoing object of the present invention, the present invention provides a phase retarder film that is used to be mounted on an outer surface of a polarizer and comprises:

a plurality of first phase retarder rows; and

a plurality of second phase retarder rows being arranged alternately with the first phase retarder rows, wherein each two of the adjacent first phase retarder rows and the second phase retarder rows have a non- retardation row disposed therebetween, and the non-retardation row has a optical axis that is perpendicular to or parallel to a transmission axis of the polarizer.

In one embodiment of the present invention, the non-retardation row is a liquid crystal layer with an optical axis that is perpendicularly or parallelly aligned with the transmission axis of the polarizer of the liquid crystal display panel.

In one embodiment of the present invention, the phase retarder film is a multilayer optical film constituted by a quarter-wave liquid crystal retarder film and a patterned half-wave liquid crystal retarder film.

In one embodiment of the present invention, the patterned half-wave liquid crystal retarder film has a plurality of half-wave phase retarder rows being arranged at intervals; and the quarter-wave liquid crystal retarder film is mounted on the patterned half-wave liquid crystal retarder film.

In one embodiment of the present invention, the patterned half-wave liquid crystal retarder film further includes a plurality of isotropic material rows, and the half-wave phase retarder rows are arranged alternately with the isotropic material rows; the first phase retarder rows are constituted by the quarter-wave liquid crystal retarder film and the half-wave phase retarder rows; and the second phase retarder rows are constituted by the quarter-wave liquid crystal retarder film and the isotropic material rows.

In one embodiment of the present invention, an angle between an optical axis of each of the first phase retarder rows and the transmission axis of the polarizer is 135 degrees; and an angle between an optical axis of each of the second phase retarder rows and the transmission axis of the polarizer is 45 degrees.

The present invention further provides a 3D display device comprising:

a liquid crystal display panel having a light-exiting side;

a polarizer mounted on the light-exiting side of the liquid crystal display panel; and

a phase retarder film mounted on an outer surface of the polarizer and having:
a plurality of first phase retarder rows; and
a plurality of second phase retarder rows being arranged alternately with the first phase retarder rows, wherein each two of the adjacent first phase retarder rows and the second phase retarder rows have a non-retardation row disposed therebetween, and the non-retardation row has an optical axis that is perpendicular to or parallel to a transmission axis of the polarizer.

In one embodiment of the present invention, the non-retardation row is a liquid crystal layer with an optical axis that is perpendicularly or parallelly aligned with the transmission axis of the polarizer of the liquid crystal display panel.

In one embodiment of the present invention, the phase retarder film is a multilayer optical film constituted by a quarter-wave liquid crystal retarder film and a patterned half-wave liquid crystal retarder film.

In one embodiment of the present invention, the patterned half-wave liquid crystal retarder film has a plurality of half-wave phase retarder rows being arranged at intervals; and the quarter-wave liquid crystal retarder film is mounted on the patterned half-wave liquid crystal retarder film.

The present invention further provides another phase retarder film. The phase retarder film is a multilayer optical film constituted by a quarter-wave liquid crystal retarder film and a patterned half-wave liquid crystal retarder film and is used to be disposed on an outer surface of a polarizer of the liquid crystal display panel, wherein the liquid crystal display panel has a plurality of pixel rows and black matrix disposed between the adjacent pixel rows; and the phase retarder film comprises:

a plurality of first phase retarder rows; and

a plurality of second phase retarder rows being arranged alternately with the first phase retarder rows, wherein each two of the adjacent first phase retarder rows and the second phase retarder rows have a non-retardation row disposed therebetween, and the non-retardation row is a liquid crystal layer with an optical axis that is perpendicularly or parallelly aligned with a transmission axis of the polarizer of the liquid crystal display panel, and the non-retardation row corresponds to the position of the black matrix between the adjacent pixel rows.

The present invention is to dispose non-retardation rows having an optical axis perpendicularly or parallelly aligned with a transmission axis of a polarizer at boundary regions of phase-retarding areas, where image-crosstalk may occur, so as to reduce output-light brightness at the boundary regions and further improve possible image-crosstalk.

### BRIEF DESCRIPTION OF THE DRAWINGS

FIG. 1 is a schematic view of polarization status of light of a conventional 3D display system;

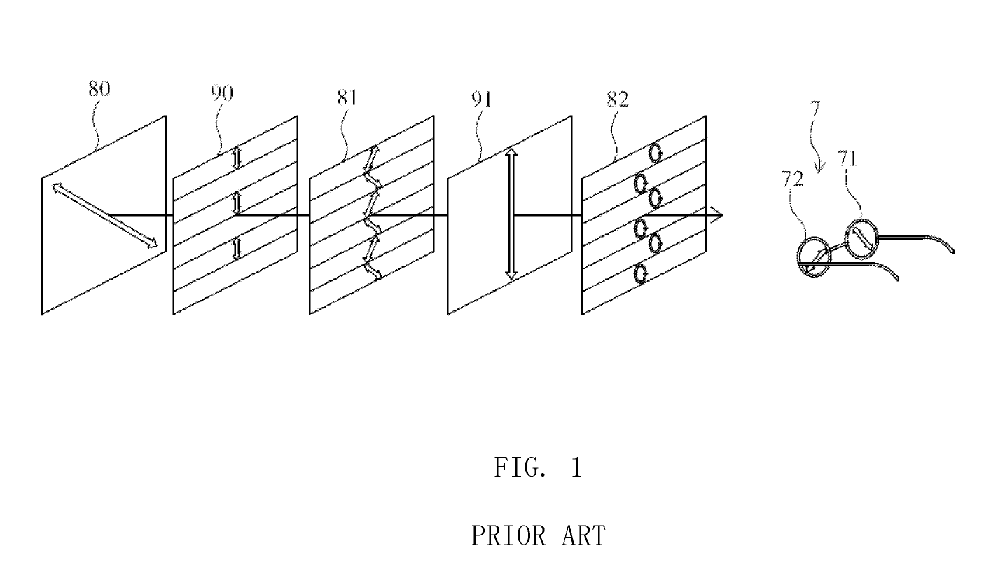

FIG. 2 is a partial schematic view of a conventional phase retarder film;

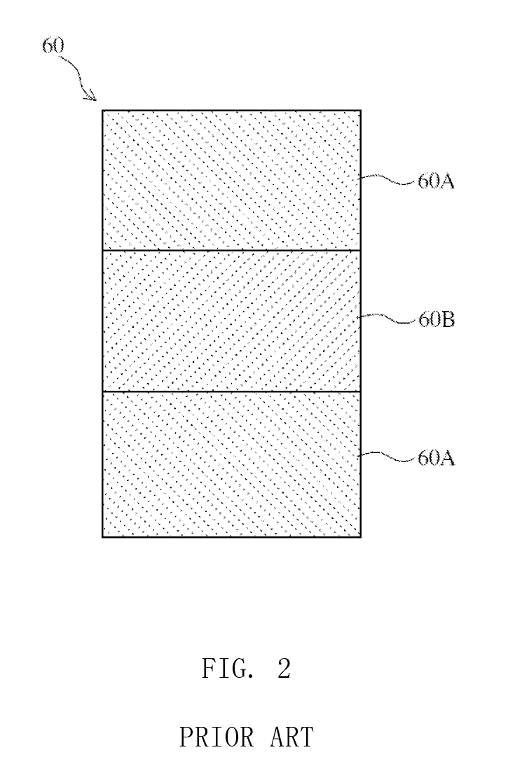

FIG. 3 is a partial schematic view showing the phase retarder film in FIG. 2 correspondingly mounted on a liquid crystal display panel;

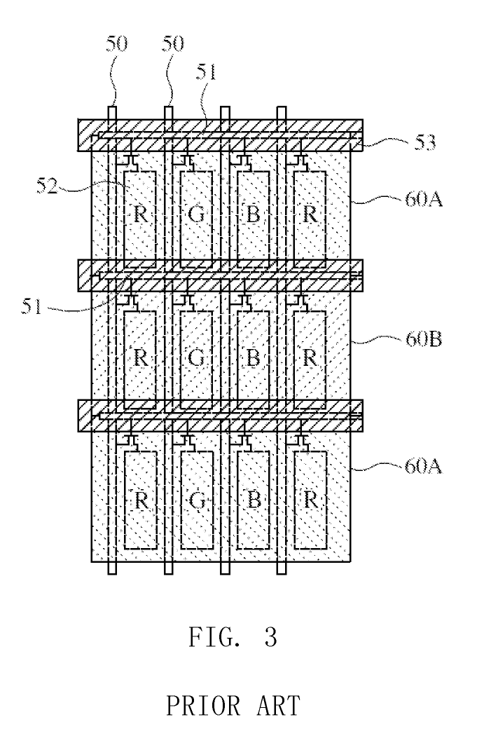

FIG. 4 is a partial schematic view of a preferred embodiment of a phase retarder film in accordance with the present invention; and

FIG. 5 is a partial schematic view showing the phase retarder film in FIG. 4 correspondingly mounted on a liquid crystal display panel.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

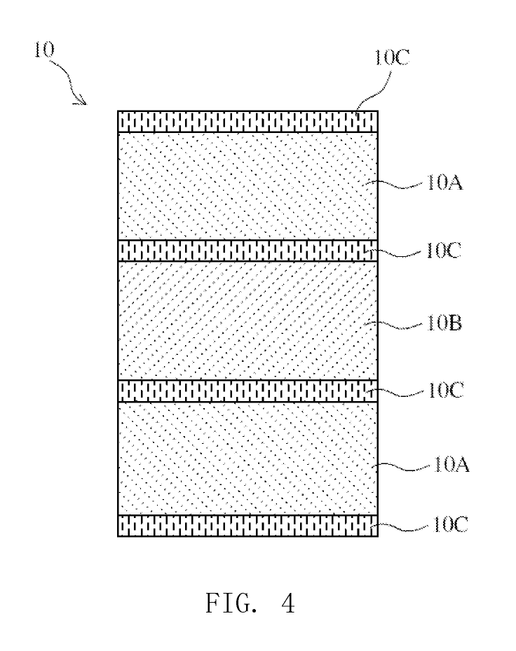

With reference FIG. 4, FIG. 4 is a partial schematic view of a preferred embodiment of a phase retarder film in accordance with the present invention. The phase retarder film of the present invention is used in a 3D display device. The 3D display comprises a liquid crystal display panel and the phase retarder film 10.

Generally speaking, the liquid crystal display panel (not shown in the figure) may include a first substrate, a second substrate, a liquid crystal layer, a first polarizer and a second polarizer. The first substrate may be a glass substrate having a color filter; and the second substrate may be a glass (or other materials) substrate having a thin film transistor array. The liquid crystal layer is mounted between the first substrate and the second substrate. The first polarizer is mounted at an outer side of the first substrate (also known as a light-output side of the first substrate). The second polarizer is mounted at an outer side of the second substrate (also known as a light-input side of the first substrate). The 3D display device further includes a backlight module mounted at the outer side of the second polarizer for providing a light source that emits light through the second polarizer.

The phase retarder film 10 is mounted at an outer surface of the first polarizer. The phase retarder film 10 comprises a plurality of first phase retarder rows 10A, a plurality of second phase retarder rows 10B and a plurality of non-retardation rows 10C. The first phase retarder rows 10A are arranged alternately with the second phase retarder rows 10B. And the first phase retarder rows 10A and the second phase retarder rows 10B are spaced from each other by intervals. The non-retardation rows 10C are disposed in the intervals between the adjacent first phase retarder rows 10A and second phase retarder rows 10B, respectively.

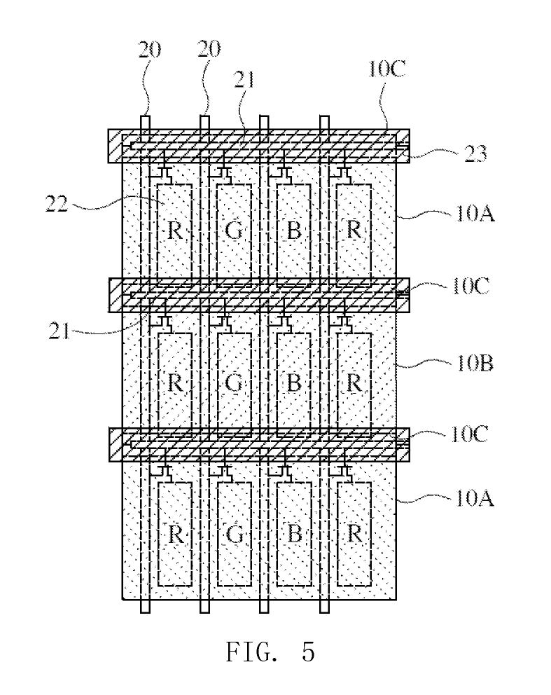

In more details, with further reference to FIG. 5, FIG. 5 is a partial schematic view showing the phase retarder film in FIG. 4 correspondingly mounted on a liquid crystal display panel. The liquid crystal display panel comprises a plurality of gate lines 21, a plurality of data lines 20 and a plurality of pixel areas defined by the gate lines 21 and the data lines 20. Each of the pixel areas has a pixel electrode 22 mounted therein. The pixel areas that are connected to the same gate line 22 are referred as a pixel row. A black matrix 23 is mounted between the adjacent pixel rows and mounted on wiring areas of the gate lines 21 and the data lines 20. The first phase retarder rows 10A correspond to the positions of the odd pixel rows (or the even pixel rows) of the liquid crystal display panel; and the second phase retarder rows 10B correspond to the positions of the even pixel rows (or the odd pixel rows) of the liquid crystal display panel. The non-retardation rows 10C correspond to the positions of the black matrix 23 between the adjacent pixel rows.

In the embodiment shown in FIG. 5, each of the non-retardation rows 10C has an optical axis perpendicular or parallel to a transmission axis of the first polarizer. An angle between an optical axis of each of the first phase retarder rows 10A and the transmission axis of the first polarizer is preferably 135 degrees (±15 degrees). An angle between an optical axis of each of the second phase retarder rows 10B and the transmission axis of the first polarizer is preferably 45 degrees (±15 degrees).

The phase retarder film 10 is preferably a multilayer optical film constituted by a quarter-wave liquid crystal retarder film and a patterned half-wave liquid crystal retarder film, wherein the patterned half-wave liquid crystal retarder film includes a plurality of half-wave phase retarder rows being arranged at intervals, and further includes a plurality of isotropic material rows that provide zero phase retardation. The half-wave phase retarder rows are arranged alternately with the isotropic material rows. The quarter-wave liquid crystal retarder film is mounted on the patterned half-wave liquid crystal retarder film. It is worth noting that the first phase retarder rows 10A are constituted by the quarter-wave liquid crystal retarder film and the half-wave phase retarder rows; and the second phase retarder rows 10B are constituted by the quarter-wave liquid crystal retarder film and the isotropic material rows. Each of the non-retardation rows 10C is preferably a liquid crystal layer with an optical axis that is perpendicularly or parallelly aligned with the transmission axis of the polarizer of the liquid crystal display panel and has a width preferably ranging between 0 mm and 100 mm.

The phase retarder film 10 including the multilayer optical film having the quarter-wave liquid crystal retarder film and the pattern half-wave retarder film and the liquid crystal layer with an optical axis that is perpendicularly or parallelly aligned with a transmission axis of the polarizer of the liquid crystal display panel is preferably formed by applying UV reactive liquid crystal materials on an alignment film to form the first phase retarder rows 10A, the second phase retarder rows 10B and the non-retardation rows 10C.

The word theory of the 3D display device and the phase retarder film 10 thereof of the present invention is described as follows:

The first polarizer of the liquid crystal display panel converts output light from the liquid crystal display panel into linearly polarized light. The linearly polarized light then passes through the phase retarder film 10, wherein the linearly polarized light that passes through the first phase retarder rows 10A is converted into left-handed circularly polarized light (or right-handed circularly polarized light); the linearly polarized light that passes through the second phase retarder rows 10B is converted into right-handed circularly polarized light (or left-handed circularly polarized light); and the linearly polarized light that passes through the non-retardation rows 10C remains the same since the optical axis of the non-retardation rows 10C is perpendicular to (or parallel to) the transmission axis of the first polarizer. The user can wear a pair of circularly polarized glasses to receive the left-handed circularly polarized light and the right-handed circularly polarized light respectively with his two eyes to generate a three-dimensional visual effect.

Because the brightness of the linearly polarized light passing through the circularly polarized glasses is lower than the brightness of the circularly polarized light passing through the circularly polarized glasses, therefore when the phase retarder film 10 has a positional shift caused by the attachment error of an attachment machine, the brightness of wrong images will be lower. Hence, the image crosstalk phenomenon can be improved.

By the above description, comparing with the shortcomings of the conventional technology, the present invention mounts non-retardation rows having an optical axis perpendicularly or parallelly aligned with a transmission axis of a polarizer at boundary regions of phase-retarding areas, where image-crosstalk may occur, so as to reduce output-light brightness at the boundary regions and further improve possible image-crosstalk.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A phase retarder film which is a multilayer optical film constituted by a quarter-wave liquid crystal retarder film and a patterned half-wave liquid crystal retarder film and is used to be disposed on an outer surface of a polarizer of the liquid crystal display panel, wherein the liquid crystal display panel has a plurality of pixel rows and black matrix disposed between the adjacent pixel rows; and the phase retarder film comprises:
a plurality of first phase retarder rows; and
a plurality of second phase retarder rows being arranged alternately with the first phase retarder rows, wherein each two of the adjacent first phase retarder rows and the second phase retarder rows have a non-retardation row disposed therebetween, and the non-retardation row is a liquid crystal layer with an optical axis that is perpendicularly or parallelly aligned with a transmission axis of the polarizer of the liquid crystal display panel, and the non-retardation row corresponds to the position of the black matrix between the adjacent pixel rows.

2. The phase retarder film as claimed in claim 1, wherein the phase retarder film is a multilayer optical film constituted by a quarter-wave liquid crystal retarder film and a patterned half-wave liquid crystal retarder film; the patterned half-wave liquid crystal retarder film has a plurality of half-wave phase retarder rows being arranged with intervals therebetween; and the quarter-wave liquid crystal retarder film is mounted on the patterned half-wave liquid crystal retarder film.

3. A phase retarder film that is used to be mounted on an outer surface of a polarizer, comprising:
a plurality of first phase retarder rows; and
a plurality of second phase retarder rows being arranged alternately with the first phase retarder rows, wherein each two of the adjacent first phase retarder rows and the second phase retarder rows have a non-retardation row disposed therebetween, and the non-retardation row has a optical axis that is perpendicular to or parallel to a transmission axis of the polarizer.

4. The phase retarder film as claimed in claim 3, wherein the non-retardation row is a liquid crystal layer with an optical axis that is perpendicularly or parallelly aligned with the transmission axis of the polarizer of the liquid crystal display panel.

5. The phase retarder film as claimed in claim 3, wherein the phase retarder film is a multilayer optical film constituted by a quarter-wave liquid crystal retarder film and a patterned half-wave liquid crystal retarder film.

6. The phase retarder film as claimed in claim 5, wherein the patterned half-wave liquid crystal retarder film has a plurality of half-wave phase retarder rows being arranged at intervals; and the quarter-wave liquid crystal retarder film is mounted on the patterned half-wave liquid crystal retarder film.

7. The phase retarder film as claimed in claim 6, wherein the patterned half-wave liquid crystal retarder film further includes a plurality of isotropic material rows, and the half-wave phase retarder rows are arranged alternately with the isotropic material rows;
the first phase retarder rows are constituted by the quarter-wave liquid crystal retarder film and the half-wave phase retarder rows; and
the second phase retarder rows are constituted by the quarter-wave liquid crystal retarder film and the isotropic material rows.

8. The phase retarder film as claimed in claim 6, wherein an angle between an optical axis of each of the first phase retarder rows and the transmission axis of the polarizer is 135 degrees; and an angle between an optical axis of each of the second phase retarder rows and the transmission axis of the polarizer is 45 degrees.

9. A 3D display device comprising:
a liquid crystal display panel having a light-exiting side;
a polarizer mounted on the light-exiting side of the liquid crystal display panel; and
a phase retarder film mounted on an outer surface of the polarizer and having:
a plurality of first phase retarder rows; and
a plurality of second phase retarder rows being arranged alternately with the first phase retarder rows, wherein each two of the adjacent first phase retarder rows and the second phase retarder rows have a non-retardation row disposed therebetween, and the non-retardation row has an optical axis that is perpendicular to or parallel to a transmission axis of the polarizer.

10. The 3D display device as claimed in claim 9, wherein the non-retardation row is a liquid crystal layer with an optical axis that is perpendicularly or parallelly aligned with the transmission axis of the polarizer of the liquid crystal display panel.

11. The 3D display device as claimed in claim 10, wherein the phase retarder film is a multilayer optical film constituted by a quarter-wave liquid crystal retarder film and a patterned half-wave liquid crystal retarder film.

12. The 3D display device as claimed in claim 11, wherein the patterned half-wave liquid crystal retarder film has a plurality of half-wave phase retarder rows being arranged at intervals; and the quarter-wave liquid crystal retarder film is mounted on the patterned half-wave liquid crystal retarder film.
